(19) United States
(12) Patent Application Publication
(10) Pub. No.: US 2012/0156331 A1
(43) Pub. Date: Jun. 21, 2012

(54) CHEESE-LIKE FOOD COMPOSITION AND A METHOD FOR PRODUCING THE SAME

(76) Inventors: Wenxue Han, Osaka (JP); Masaki Nakamura, Osaka (JP); Ryota Fuse, Osaka (JP)

(21) Appl. No.: 12/971,120

(22) Filed: Dec. 17, 2010

(51) Int. Cl. A23J 1/20; A23D 9/00

(52) U.S. Cl. 426/61; 426/656; 426/601

(57) ABSTRACT

An object of the present invention is to provide a cheese-like food composition having physical properties and texture analogous to those of soft cheese and comprising a plant protein as a protein ingredient. The present inventors have discovered that the above object can be achieved by a food composition having cheese-like texture, which comprises a soy protein in an amount ranging from 0.5% to 10% by mass as a solid content and a wheat protein in an amount ranging from 15% to 35% by mass as a solid content with respect to the total amount of the food composition, wherein the soy protein is coagulated.

### FIELD OF THE INVENTION

The present invention provides a cheese-like food composition containing a plant protein as a main ingredient and a method for producing the cheese-like food composition.

### BACKGROUND OF THE INVENTION

Because of requirements such as the needs to reduce animal protein intake, reduce costs, and improve nutritional value, a cheese-like food is under development as a cheese substitute containing a plant protein as a main ingredient.

JP Patent Publication (Kokai) No. 60-78541 A (1985) discloses a method for producing a cheese-like food, comprising kneading and then heating a formulation containing tofu with a 10%-50% soybean solid content, a fat or oil, a thermocoagulable substance, and a stabilizer. JP Patent Publication (Kokai) No. 60-78541 A (1985) discloses that hard to soft cheese-like foods can be obtained by the method.

JP Patent Publication (Kokai) No. 55-88653 A (1980) discloses a method for producing a cheese-like food, comprising kneading and then heating a formulation containing at least 1.5 parts by weight of water and 0.5-3 parts by weight of an edible fat or oil with respect to 1 part by weight of protein in a mixture of a soy protein and a wheat protein. The JP Patent Publication also discloses that the weight ratio of a soy protein to a wheat protein preferably ranges from 1:1 to 1:0.1. According to JP Patent Publication (Kokai) No. 55-88653 A (1980), a cheese-like food having a velvety and resilient texture like cheese is provided by the method.

JP Patent Publication (Kokoku) No. 46-5025 B (1971) discloses a method for producing a cheese-like soy protein food comprising adding lactic acid bacteria and carrying out fermentation and maturation.

JP Patent Publication (Kokai) No. 59-59151 A (1984) discloses a method for producing a novel gelatinous food, comprising causing transglutaminase to act on an emulsified liquid containing a protein, a fat or oil, and water, so as to make the liquid gelatinous. This publication describes cheese as a specific example of the gelatinous food.

### SUMMARY OF THE INVENTION

Cheese-like foods have been conventionally developed as described above. However, no cheese-like foods obtained by any conventional method have sufficient texture compared with actual cheese. In particular, cheese-like foods having the same texture and physical properties (and in particular, a stringy quality that allows pizza toast cheese to stretch like a long string) as soft cheese have not yet been provided.

Hence, an object of the present invention is to provide a cheese-like food composition having physical properties and texture analogous to those of soft cheese and comprising a plant protein as a protein ingredient.

The present inventors have surprisingly found that a cheese-like food having physical properties and texture analogous to those of soft cheese is formed by formulating a soy protein and a wheat protein at conventionally unknown specific concentrations in a cheese-like food composition, and then coagulating the soy protein. The present invention encompasses the following (1) to (9).

(1) A food composition having cheese-like texture, containing 0.5% to 10% by mass of a soy protein as a solid content and 15% to 35% by mass of a wheat protein as a solid content with respect to the total amount of the food composition, wherein the soy protein is coagulated.

(2) The food composition according to (1), wherein the soy protein is prepared by coagulating an emulsion of the soy protein with a coagulant, crushing the coagulated material, and then coagulating the crushed material.

(3) The food composition according to (1) or (2), further comprising transglutaminase and/or a fat or oil.

(4) The food composition according to any one of (1) to (3), wherein the soy protein is coagulated by heating and/or addition of a coagulant.

(5) The food composition according to any one of (1) to (4), having cheese-like texture with a stringy quality.

(6) A method for producing a food composition having cheese-like texture, comprising mixing raw materials including 0.5% to 10% by mass of a soy protein as a solid content and 15% to 35% by mass of a wheat protein as a solid content with respect to the total amount of raw materials, and coagulating the soy protein via heating and/or addition of a coagulant.

(7) The method according to (6), wherein the soy protein as a raw material is a crushed material formed in advance by coagulating an emulsion of the soy protein with a coagulant and then crushing the coagulated material.

(8) The method according to (6) or (7), wherein the raw materials further include transglutaminase and/or a fat or oil.

(9) The method according to any one of (6) to (8), comprising:
homogenizing raw materials including a soy protein and water, adding a coagulant and carrying out mixing, adding a wheat protein and carrying out mixing, and then heating the resultant;
homogenizing raw materials, including a soy protein and water, adding a coagulant and carrying out mixing, adding a wheat protein and carrying out mixing, and then allowing the resultant to stand; or,
homogenizing raw materials including a soy protein and water, adding a wheat protein and carrying out mixing, and then heating the resultant.

### EFFECT OF THE INVENTION

A cheese-like food composition provided according to the present invention has physical properties and texture analogous to those of soft cheese.

### DETAILED DESCRIPTION OF THE INVENTION

### 1. Raw Materials and Formulation

The cheese-like food composition of the present invention is characterized by containing, with respect to the total amount of the food composition (represented by the total wet weight of the cheese-like food composition), 0.5% to 10% by mass of a soy protein as a solid content and 15% to 35% by mass of a wheat protein as a solid content. Combining the 2 types of protein in amounts within such ranges surprisingly imparts texture and stretch property (a stringy quality) of soft cheese to the product. The amount of a soy protein formulated particularly preferably ranges from 1% to 4% by mass as a solid content with respect to the total amount (wet weight) of the food composition. The amount of a wheat protein formulated particularly preferably ranges from 20% to 30% by mass as a solid content with respect to the total amount (wet weight) of the food composition. In this specification, the amount of each raw material used is described in terms of percentage accounted for by the relevant raw material in the total wet weight of the cheese-like food composition, unless otherwise specified.

A soy protein to be used as a raw material may be present in any form. For example, an isolated soy protein, defatted soybean cake, soybean powder, soy milk, soy milk powder, or the like can be used. Any material may be in a solid form, such as powder, or in a liquid form prepared by dissolving or suspending the material in water. Also, a soy protein can also be used in the form of a crushed material prepared by coagulating an emulsion of the soy protein with a coagulant and then crushing the coagulated material (that is, tofu or a tofu analog). The amount of an above soy protein formulated is calculated based on the solid content of the soy protein included among the raw materials, regardless of the forms of the raw materials.

A wheat protein to be used as a raw material may be present in any form. For example, a wheat protein in the form of gluten, gliadin, or the like can be used. Any of these materials may be in a solid form, such as powder, or in a liquid form prepared by dissolving or suspending the material in water. The amount of an above wheat protein formulated is calculated based on the solid content of the wheat protein included among raw materials, regardless of the forms of the raw materials.

Cheese-like texture is formed with a combination of a coagulated soy protein and a wheat protein having viscous elasticity. Specifically, in the present invention, a soy protein is coagulated in a raw-material mixture containing a soy protein and a wheat protein at specific concentrations, and the viscous elasticity of the wheat protein is imparted to texture. Thus, provision of a soft cheese-like food composition preferably having a stringy quality becomes possible.

The amount of water in the food composition of the present invention preferably ranges from 15% to 55% by mass and preferably ranges from 30% to 45% by mass. Water may be added as a part of a raw material, such as in the form of a crushed material prepared by coagulating an emulsion of a soy protein with a coagulant and then crushing the coagulated material.

The food composition of the present invention further preferably contains a fat or oil. A fat or oil is preferably contained in an amount ranging from 0.01% to 40% by mass and preferably ranging from 15% to 30% by mass with respect to the total amount of the food composition. Addition of a fat or oil to the food composition results in velvety sensation and physical properties and texture such as a pleasant sensation on the tongue and effective melting in the mouth. The fat or oil is not particularly limited, as long as it is an edible animal or plant fat or oil. For example, soybean oil, sunflower oil, rapeseed oil, and corn oil can be used.

The food composition of the present invention further preferably contains transglutaminase. Preferably, transglutaminase is in the form of a generally commercially available enzyme preparation and is contained in an amount ranging from 0.01% to 1% by mass with respect to the total amount of the food composition. Addition of transglutaminase enables the food composition to have adequate resilient texture and can prevent the product from having a gum-like physical property that makes chewing it difficulty.

When a soy protein is coagulated by addition of a coagulant, a food composition as a final product contains the coagulant. As a coagulant, a salt coagulant such as calcium chloride, magnesium chloride, calcium sulfate, or magnesium sulfate and an acid coagulant such as gluconic acid or lactic acid can be used. The amount of a coagulant added is not particularly limited, as long as it is sufficient for coagulation of the soy protein. Typically, the amount of a coagulant as a solid content ranges from 0.1% to 1% by mass with respect to the total amount of the food composition.

In the food composition of the present invention, a seasoning, an aroma chemical, a dye, and/or the like can be formulated as required in appropriate amounts.

### 2. Production Method

The food composition having cheese-like texture of the present invention can be produced by a method comprising mixing raw materials including at least predetermined amounts of a soy protein and a wheat protein, and then coagulating the soy protein. A soy protein is particularly preferably coagulated using heat coagulation and the addition of a coagulant in combination. This is because the resulting food has properties closest to the properties of cheese in terms of firmness, tongue sensation, and the sensation of melting in the mouth.

The order in which a soy protein, a wheat protein, and other ingredients are added and the timing for coagulation treatment are not particularly limited.

In an embodiment in which a crushed material prepared by coagulating an emulsion of a soy protein with a coagulant and then crushing the coagulated material (that is, tofu or a tofu analog) is used as a raw material (soy protein), steps that are preferably carried out are as follows: a step of mixing the crushed material with other raw material ingredients such as a wheat protein and a step of further coagulating the soy protein by heating the mixture obtained in the previous step, adding a coagulant to the mixture, or adding a coagulant to the mixture and then heating the resultant.

In an embodiment in which transglutaminase is formulated, a step of maintaining a raw-material mixture, containing transglutaminase at a temperature ranging from 25° C. to 60° C. for 5 to 60 minutes is further preferably carried out to cause transglutaminase to act. The above temperature indicates the temperature of the raw-material mixture. In this specification, unless otherwise particularly explained, such temperatures indicate the temperatures of subjects.

In an embodiment in which transglutaminase is formulated, a step of heating a raw-material mixture on which transglutaminase has been caused to act is further preferably carried out to inactivate transglutaminase at an inactivation temperature (about 90° C.) for several minutes.

The heating step for causing transglutaminase to act and the heating step for inactivating transglutaminase are carried out in combination with a step of heat-coagulation of a soy protein in a raw-material mixture.

2.1. Embodiment in which Coagulation is Carried Out Using Addition of Coagulant and Heat-Coagulation in Combination

An example of the method of the present invention comprising using addition of a coagulant and heat coagulation in combination as coagulation treatment of a soy protein is a method comprising a step of mixing water, a soy protein, a wheat protein, a coagulant, and other raw materials and a heating step of heating the thus obtained mixture so as to coagulate the soy protein.

During the mixing step, coagulation due to the action of a coagulant proceeds to some extent. Procedures for mixing raw materials are not particularly limited and can be adequately determined depending on the mixing means to be employed. All raw materials may be added simultaneously and then mixed, or they may be added in order and then mixed. In an embodiment, raw materials including a soy protein and water, and, if necessary, further including other ingredients (other than a wheat protein and a coagulant) such as a fat or oil are homogenized using a stirring homogenizer, a high pressure homogenizer, or the like. A coagulant and a wheat protein are then added to the homogenate and carrying out mixing all raw materials. Preferably, the coagulant is added to and mixed with the above homogenate and then the wheat protein is added to and mixed with the resultant. Raw materials other than a wheat protein and a coagulant, including a soy protein and water (and in particular, raw materials including a soy protein, water, and a fat or oil) are homogenized in advance, so that a cheese-like food composition having homogenous texture can be provided. When a soy protein and water are used in the form of a crushed material prepared by coagulating an emulsion of the soy protein with a coagulant and then crushing the coagulated material (that is, tofu and a tofu analog), the above coagulated product is preferably crushed in advance with a mixer or the like.

The thus obtained mixture can be processed into a desired form and then subjected to a heating step. For example, a mold-shaped closed vessel is filled with the thus obtained mixture and then the vessel containing the mixture can be heated.

The temperature for the heating step preferably ranges from 25° C. to 60° C. and the heating time preferably ranges from 5 to 60 minutes. During the heating step, the action of transglutaminase also proceeds in an embodiment in which transglutaminase is formulated.

An embodiment comprising formulating transglutaminase further preferably comprises a step of heating the mixture at a temperature (about 90° C.) that inactivates the enzyme for several minutes.

2.2. Embodiment in which Coagulation is Carried Out with the Addition of Coagulant Alone

An example of the method of the present invention in which the addition of a coagulant alone is carried out as coagulation treatment for a soy protein is a method comprising a step of mixing water, a soy protein, a wheat protein, a coagulant, and other raw materials and a step of leaving the thus obtained mixture to stand for coagulation of the soy protein. As procedures for the mixing step, procedures similar to those explained in 2.1 above can be employed. Specifically, all raw materials may be mixed at once or may be added in order and then mixed. Further alternatively, a coagulant and a wheat protein may be added to and mixed with a material prepared by homogenizing in advance raw materials including a soy protein and water, and, if necessary, ingredients other than a wheat protein and a coagulant, such as a fat or oil. Also, before and/or after the step of leaving the thus obtained mixture to stand, the thus obtained mixture can be processed into a desired form.

The mixture is preferably left to stand at an atmospheric temperature ranging from 10° C. to 40° C. for 1 to 15 minutes.

An embodiment comprising formulating transglutaminase further preferably comprises the above heating step for inactivation of the enzyme.

### 2.3. Embodiment Comprising Carrying Out Coagulation by Heat Coagulation Alone

An example of the method of the present invention comprising carrying out heat coagulation alone as coagulation treatment for a soy protein is a method comprising a mixing step of mixing water, a soy protein, a wheat protein, and other raw materials and a heating step of heating the thus obtained mixture to coagulate the soy protein.

Procedures for mixing raw materials are not particularly limited and can be adequately determined depending on the mixing means employed herein. All raw materials may be added simultaneously and then mixed or may be separately added in order followed by homogenization. In an embodiment, raw materials including a soy protein and water, and, if necessary, ingredients other than a wheat protein, such as a fat or oil, are homogenized using a stirring homogenizer, a high pressure homogenizer, or the like. Following this, a wheat protein is added to the homogenate and then the resultant is mixed, so that all raw materials are mixed.

The thus obtained mixture can be processed into a desired form and then subjected to a heating step. For example, a mold-shaped closed vessel is filled with the mixture and then the vessel containing the mixture can be heated.

As procedures for the heating step, procedures similar to those explained in 2.1 above can be employed herein.

An embodiment comprising formulating transglutaminase further preferably comprises the above heating step for inactivation of the enzyme.

### EXAMPLES

Embodiments of the present invention will be described more specifically based on Examples below.

### Example 1

### Raw Materials

TABLE 1

| | Parts by mass |
|---|---|
| Water | 37.2 |
| Soy protein | 2.1 |
| “Fuji ProF” (Fuji Oil Co., | |
| Ltd., Form: dry powder) | |
| Wheat protein | 22.0 |
| “Glia A” (Asama Chemical Co., | |
| Ltd.; Form: dry powder) | |
| Vegetable oil | 22.1 |
| Transglutaminase | 0.4 |
| Seasoning | 15.7 |
| Flavor, dye | 0.1 |
| Coagulant | 0.4 |
| (lactic acid solution with a | |
| concentration of 50% by mass) | |
| Total | 100 |

### 2. Production Steps

A soy protein and water were mixed using a mixer. The thus obtained mixture and other raw materials excluding a wheat protein and a coagulant were homogenized using a homogenizer (DX-10/NIHONSEIKI) at 3000-8000 rpm for 60 to 120 seconds.

The coagulant (lactic acid solution) was added to and mixed with the homogenate.

The wheat protein was further added to and mixed with the thus obtained mixture.

The mixture obtained by the above procedures was slice-shaped, and it was then packed in a film vessel made of resin, following which it was vacuum packaged.

The slice-shaped mixture packed in the vessel was placed in hot water for heat treatment at 55° C. for 10 minutes, so that the soy protein in the mixture was coagulated and transglutaminase was caused to act.

Moreover, the slice-shaped mixture in the vessel was placed in hot water for heat treatment at 90° C. for 2 minutes, so that the soy protein was coagulated and transglutaminase was inactivated. Then the mixture was cooled and stored in a refrigerator.

Thus, a cheese-like food was prepared.

### 3. Quality Evaluation

The cheese-like food prepared by the above steps was placed on aluminium foil and then baked for about 2 minutes using an oven toaster. The cheese-like food was removed from the oven toaster and then stretched with both hands to the right and the left while it was hot, so that its “stretch property” was evaluated. Also, a tester placed the cheese-like food in his or her mouth and then evaluated the texture in terms of firmness, resilient texture, and tongue sensation.

TABLE 2

| | Stretch property |
|---|---|
| ⊚ | Stretched by about 5 cm or more |
| ◯ | Stretched by about 3-5 cm |
| Δ | Stretched by about 1-3 cm |
| X | No stretch |

TABLE 3

| | Texture |
|---|---|
| ⊚ | Soft cheese-like texture |
| ◯ | Somewhat gum-like texture or dry and stubborn texture |
| Δ | Lower limit acceptable as soft cheese (e.g., gum-like and |
| | dry and stubborn texture) |
| X | Texture unacceptable as soft cheese (e.g., gum-like texture, |
| | causing difficulty in swallowing) |

The cheese-like food of Example 1 was evaluated as “⊚” in terms of both stretch property and texture, and thus it was evaluated as having physical properties, texture, and flavor equivalent to those of cheese having a stringy quality.

### Examples 2-5 and Comparative Examples 1-4

A cheese-like sliced food was obtained using the formulation of raw materials and procedures similar to those in Example 1 (specifically, the amounts (parts by mass) of other raw materials other than the soy protein and the wheat protein in Table 1 of Example 1 had not been altered), except that the parts by mass of the soy protein and the wheat protein had been altered. The thus obtained food was evaluated for texture and flavor using procedures and criteria similar to those in Example 1.

Table 4 shows the amounts of the soy protein and the wheat protein formulated, texture, and flavor in each Example and Comparative example.

TABLE 4

| | Amount of | Amount of | Mass ratio of | | % by mass | % by mass | | | |
|---|---|---|---|---|---|---|---|---|---|
| | wheat protein | soy protein | protein to that | | of wheat | of soy | | | |
| | formulated | formulated | in Example 1 | | protein in all | protein in all | Evaluation | | |
| | Parts by | Parts by | Wheat | Soy | raw materials | raw materials | Stretch | | |
| | mass | mass | protein | protein | % by mass | % by mass | property | Texture | Characteristics |
| Example 1 | 22.0 | 2.1 | 1 | 1 | 22 | 2.1 | ⊚ | ⊚ | |
| Example 2 | 37.4 | 2.1 | 1.7 | 1 | 33 | 1.8 | ◯ | Δ | |
| Example 3 | 15.4 | 2.1 | 0.7 | 1 | 17 | 2.2 | Δ | ◯ | |
| Example 4 | 22.0 | 8.4 | 1 | 4 | 21 | 7.9 | Δ | Δ | |
| Example 5 | 22.0 | 0.7 | 1 | 0.33 | 22 | 0.7 | ⊚ | ◯ | |
| Comparative | 44.0 | 2.1 | 2 | 1 | 36 | 1.7 | ◯ | X | Gum-like |
| example 1 | | | | | | | | | |
| Comparative | 11.0 | 2.1 | 0.5 | 1 | 12 | 2.4 | X | X | Not coagulated |
| example 2 | | | | | | | | | |
| Comparative | 22.0 | 12.6 | 1 | 6 | 20 | 11.4 | Δ | X | Dry and stubborn |
| example 3 | | | | | | | | | texture |
| Comparative | 22.0 | 0.0 | 1 | 0 | 23 | 0 | ⊚ | X | Gum-like |
| example 4 | | | | | | | | | |

### Example 6

Tofu was homogenized using a homogenizer (DX-10/NIHONSEIKI) at 3000-8000 rpm for 60-120 seconds, so as to prepare a tofu paste with a median diameter of about 10μ. The thus prepared tofu paste (40 parts by mass) (when 40 parts by mass of the tofu paste was used, 2.1% by mass of the soy protein was included as a solid content among the raw materials) was used instead of a mixture prepared by mixing 2.1 parts by mass of the soy protein and 37.2 parts by mass of water using a mixer. Except for such a use of the tofu paste, a cheese-like sliced food was obtained in a manner similar to that in Example 1. Quality of the thus obtained food was equivalent to that of the food obtained in Example 1.

### Example 7

### Example in which No Transglutaminase is Used

### 1. Raw Materials

TABLE 5

| | Parts by mass |
|---|---|
| Water | 38.0 |
| Soy protein | 2.1 |
| “Fuji ProF” (Fuji Oil Co., | |
| Ltd., Form: dry powder) | |
| Wheat protein | 22.0 |
| “Glia A” (Asama Chemical Co., | |
| Ltd., Form: dry powder) | |
| Vegetable fats and oils | 21.7 |
| Seasoning | 15.7 |
| Flavor, dye | 0.1 |
| Coagulant | 0.4 |
| (lactic acid solution with a | |
| concentration of 50% by mass) | |
| Total | 100 |

### 2. Production Steps

The soy protein and water were mixed using a mixer. The thus obtained mixture and raw materials excluding a wheat protein and a coagulant were mixed and homogenized using a homogenizer (DX-10/NIHONSEIKI) at 3000-8000 rpm for 60-120 seconds.

The coagulant (lactic acid) was added to and mixed with the thus obtained homogenate. Each raw material used herein was the same as that in Example 1.

The wheat protein was further added to and mixed with the thus obtained mixture.

The mixture obtained by the above procedures was left to stand at an atmospheric temperature of 25° C. for 5 minutes, slice-shaped, and then packed in a film vessel made of resin, following which it was vacuum packaged.

### 3. Quality Evaluation

Evaluation was carried out using the same procedures as those in Example 1. The “stretch property” was scored as “⊚” and the “texture” was scored as “Δ.” Thus, it was confirmed that the food had physical properties, texture, and flavor equivalent to those of cheese having a stringy quality.

### Example 8

A cheese-like sliced food was obtained in a manner similar to that in Example 7, except that magnesium chloride was used as a coagulant instead of lactic acid. The quality of the thus obtained food was evaluated as follows. The “stretch property” was scored as “⊚” and the “texture” was scored as “Δ.” The cheese-like sliced food had quality equivalent to that of the cheese-like food obtained in Example 7.

### Example 9

A cheese-like sliced food was obtained using the same procedures as those in Example 1, except that no coagulant was used, 38.0 parts by mass of water were used, and the steps of adding a coagulant to homogenized raw materials and subsequently carrying out mixing were not carried out. The quality of the thus obtained food was evaluated as follows. The “stretch property” was scored as “⊚” and the “texture” was scored as “◯.” The cheese-like sliced food had quality almost equivalent to that of the food obtained in Example 1.

What is claimed is:

1. A food composition having cheese-like texture, containing 0.5% to 10% by mass of a soy protein as a solid content and 15% to 35% by mass of a wheat protein as a solid content with respect to the total amount of the food composition, wherein the soy protein is coagulated.

2. The food composition according to claim 1, wherein the soy protein is prepared by coagulating an emulsion of the soy protein with a coagulant, crushing the coagulated material, and then coagulating the crushed material.

3. The food composition according to claim 1, further comprising transglutaminase and/or a fat or oil.

4. The food composition according to claim 1, wherein the soy protein is coagulated by heating and/or addition of a coagulant.

5. The food composition according to claim 1, having cheese-like texture with a stringy quality.

6. A method for producing a food composition having cheese-like texture, comprising mixing raw materials including 0.5% to 10% by mass of a soy protein as a solid content and 15% to 35% by mass of a wheat protein as a solid content with respect to the total amount of raw materials, and coagulating the soy protein via heating and/or addition of a coagulant.

7. The method according to claim 6, wherein the soy protein as a raw material is a crushed material formed in advance by coagulating an emulsion of the soy protein with a coagulant and then crushing the coagulated material.

8. The method according to claim 6, wherein the raw materials further include transglutaminase and/or a fat or oil.

9. The method according to claim 6, comprising:
homogenizing raw materials including a soy protein and water, adding a coagulant and carrying out mixing, adding a wheat protein and carrying out mixing, and then heating the resultant;
homogenizing raw materials, including a soy protein and water, adding a coagulant and carrying out mixing, adding a wheat protein and carrying out mixing, and then allowing the resultant to stand; or,
homogenizing raw materials including a soy protein and water, adding a wheat protein and carrying out mixing, and then heating the resultant.
